(19) United States
(12) Patent Application Publication
(10) Pub. No.: US 2023/0397557 A1
(43) Pub. Date: Dec. 14, 2023

(54) VERTICAL FARMING SYSTEM AND METHOD FOR MONITORING AND CONTROLLING PLANT GROWTH

(71) Applicant: Farmie Technologies GmbH, Berlin (DE)

(72) Inventors: Leandro Vergani, Berlin (DE); Ema Simurda, Berlin (DE)

(73) Assignee: Farmie Technologies GmbH, Berlin (DE)

(21) Appl. No.: 17/838,336

(22) Filed: Jun. 13, 2022

(51) Int. Cl. A01G 31/06; A01G 7/04

(52) U.S. Cl. CPC A01G 31/06; A01G 7/04

(57) ABSTRACT

The present invention relates to vertical farming system comprising a hydroponic system, the hydroponic system comprising:
a plurality of trays arranged above each other along a first extension direction, the trays each having a top side facing along the first extension direction, wherein the plurality of trays comprises a bottom tray, one or more intermediate trays and a top tray, the bottom tray being arranged at a bottom portion of the farming system, wherein the bottom tray faces with its top side toward the one or more intermediate trays and toward the top tray, wherein the top tray is arranged at a top portion of the farming system such that the one or more intermediate trays are between the top tray and the bottom tray,
a liquid circulation system comprising a liquid pump, the circulation system being arranged and configured to pump a liquid onto the top side of the top tray and
a liquid conduit system fluidically connecting adjacent trays of the plurality of trays,

wherein the farming system is configured such that when the liquid circulation system pumps the liquid onto the top side of the top tray, the liquid is conducted downwards via the top side of each tray by the liquid conduit system and wherein the liquid circulation system is adapted and configured to intermittently and/or continuously pump the liquid back onto the top side of the top tray so as to form a liquid circuit.

The invention further relates to a method for monitoring and controlling plant growth.

### FIELD

The present invention relates to a vertical farming system and a method for monitoring and controlling plant growth.

### BACKGROUND

Urbanization, the trend of an increasing fraction of the world population living in urban surroundings rather than in rural areas, has become a signature of our times. And despite, or precisely because of more and more people living in those urban surroundings the awareness, interest and desire of people for nature and sustainability rises. This development has for instance resulted in a promising market for farming systems that are adapted to be used in urban environments and outside natural growing areas, particularly outside rural areas. These kind of farming systems are particularly adapted for urban places with crowded places, such as supermarkets, but they may also be adapted for use at home, in the private sector. Due to the space-saving arrangement of trays used to accommodate plants and/or herbs vertically above each other—rather than horizontally next to each other, which has been the traditional way of growing plants for thousands of years, this kind of farming systems are also referred to as vertical farming systems.

The prior art thus includes various types of vertical farming systems which, however, leave room for improvement particularly with respect to their hydroponics, their usability and their energy efficiency, while offering a likewise appealing and functional structure.

Based on this, it is subject of the present invention to provide a vertical farming system that is improved with respect to the prior art, particularly with respect to their hydroponics, their usability and their energy efficiency, while offering a likewise appealing and functional structure as well as to provide a method for monitoring and controlling plant growth using such a vertical farming system.

This task is solved by a vertical farming system as claimed herein as well as the claimed method for monitoring and controlling plant growth. Advantageous embodiments of the invention are given in the corresponding subclaims and described in the following.

### SUMMARY

A first aspect of the invention relates to a vertical farming system comprising a hydroponic system, the hydroponic system comprising:
a plurality of trays arranged above each other along a first extension direction, the trays each having a top side facing along the first extension direction, wherein the plurality of trays comprises a bottom tray, one or more intermediate trays and a top tray, the bottom tray being arranged at a bottom portion of the farming system, wherein the bottom tray faces with its top side toward the one or more intermediate trays and toward the top tray, wherein the top tray is arranged at a top portion of the farming system such that the one or more intermediate trays are between the top tray and the bottom tray,
a liquid circulation system comprising a liquid pump, the circulation system being arranged and configured to pump a liquid onto the top side of the top tray and
a liquid conduit system fluidically connecting adjacent trays of the plurality of trays,

wherein the farming system is configured such that when the liquid circulation system pumps the liquid onto the top side of the top tray, the liquid is conducted downwards via the top side of each tray by the liquid conduit system and wherein the liquid circulation system is adapted and configured to intermittently and/or continuously pump the liquid back onto the top side of the top tray so as to form a liquid circuit.

In an embodiment of the invention, each tray comprises a holding member adapted and configured to hold plants on the trays, such that if the liquid is delivered by the liquid circulation system and if the plants are held on the tray, the plants are at least partially immersed in the liquid conducted via the top sides of the trays, such that a plant growth is enhanced by the liquid. For example, the holding member may be a plate or an inset arranged on or integrally formed with the tray, wherein the plate or inset comprises a plurality of recesses, such that plants and/or herbs may be arranged in the recesses. Particularly, the vertical farming system may comprise substrates that are configured to be arranged on the trays and/or in the recesses. As such, the substrate may act like a sponge and contribute to an enhanced water supply of herbs and/or plants arranged on the substrate, by at least partially immersing the substrate with the plants and/or herbs inside the liquid running across the trays. For example, the substrate may comprise or be a rockwool substrate, which is particularly advantageously from the ecologic point of view due to the recycling properties of rockwool.

According to another embodiment of the invention, the liquid conduit system comprises conducts arranged on or through an edge portion of the top side of the trays, wherein the conducts of adjacent trays are arranged on opposite edge portions of the top side, particularly such that when liquid is circulated in the vertical farming system, the liquid cascades across the trays and down on alternating edge portions of the trays, forming a meandering cascade.

Particularly, the top sides of the trays may comprise a polygonal shape along a second extension direction oriented perpendicularly to the first extension direction, wherein the conducts of adjacent trays are arranged on opposite corners of the polygons, particularly such that when liquid is circulated in the vertical farming system, the liquid runs diagonally across the trays. For example, the polygon may be a rectangle.

Particularly, the trays and/or the top sides of the trays may be tilted about the first extension direction, such that the liquid flow by gravity may be further controlled, particularly enhanced, by tilting the trays.

In another embodiment of the invention, the vertical farming system further comprises a ventilation system comprising a ventilator arranged and configured to cause an airflow inside the housing.

In a preferred embodiment of the invention, the vertical farming system comprises a housing, wherein the trays are arranged within the housing.

Particularly, the housing may comprise at least one opening, such that air may be conducted from an inside to an outside of the housing and/or vice versa.

The housing may comprise a first and a second portion, wherein the first portion accommodates the plurality of trays and wherein the second portion comprises a seedlings drawer configured and arranged to be moved between a first position inside the second portion of the housing and a second position in which the drawer is arranged at least partially outside the housing, particularly such that seedlings may be arranged in and/or harvested from the seedlings drawer.

In another embodiment of the invention, the vertical farming system comprises at least a first source of electromagnetic radiation configured to generate and direct a first electromagnetic radiation toward the top sides of the trays. Particularly, the first source of electromagnetic radiation may be a LED.

According to an embodiment of the invention, the vertical farming system comprises at least a second source of electromagnetic radiation configured to generate and emit a second electromagnetic radiation into the seedlings drawer.

In an embodiment of the invention, the liquid circulation system further comprises at least one liquid container configured to receive a liquid, wherein the at least one liquid container is or is configured to be fluidically connected with the liquid circulation system such that the liquid of the at least one liquid container or a plurality of liquids from a plurality of liquid containers may be pumped onto the top side of the top tray via the liquid circuit.

In yet another embodiment of the invention, the vertical farming system further comprises a lower terminal section comprising rollers, such that the vertical farming system may be moved by rolling the vertical farming system with the rollers.

Preferably, the vertical farming system comprises:
a maximum vertical extent h extending along the first extension direction and a minimum lateral extent w perpendicular to said vertical extent, wherein an aspect ratio ar=h/w is between 3 and 4, and
a total weight between 100 kg and 150 kg without herbs and/or plants and liquid,

such that the vertical farming system is configured to withstand maximum lateral forces between 125 N and 250 N without tilting.

In another embodiment of the invention, the vertical farming system further comprises sensors configured to determine a characteristic value selected from a group consisting of: a pH-value of the liquid, an electrical conductivity of the liquid, a liquid level in at least one liquid container, a temperature inside the housing.

According to an embodiment of the invention, the vertical farming system further comprises a control unit, wherein the control unit is configured to receive data from and/or to send control signals to components of the vertical farming system, wherein the components are comprised by a group consisting of: the sensors, the first source of electromagnetic radiation, the second source of electromagnetic radiation, and/or the liquid circulation system.

Particularly, the vertical farming system may comprise at least one camera, wherein the camera is directed onto the top side of the trays, such that the growth of plants and/or herbs arranged on the trays may be monitored by the camera.

A second aspect of the invention relates to a method for monitoring and controlling plant growth based on data received and/or control signals sent by the control unit of the vertical farming system, wherein the received data are evaluated by a computer processor and wherein by sending control signals to the components, the components of the vertical farming system are caused to perform an action based on the received control signals.

For the method according to the invention, plants and/or herbs to be monitored and controlled are arranged on the trays and a liquid is provided to the liquid conduit system, such that the growth of the plants and/or herbs may be monitored and controlled by the method.

According to an embodiment of the method according to the invention, the data received by the computer processor comprise information indicative of a pH-value of the liquid and/or an electrical conductivity of the liquid and/or a temperature inside the housing and/or a liquid level inside the at least one liquid container and wherein depending on the received data the computer processor issues a control signal via the control unit to at least one of the following components:
the first source of electromagnetic radiation, causing said first source to change an intensity of the first electromagnetic radiation directed toward the top sides of the trays,
the liquid circulation system, causing the liquid circulation system to adjust a liquid pumping rate, to start pumping or to stop pumping at least one liquid comprised by the at least one liquid container into the liquid circuit,
the ventilation system, causing the ventilation system to change a strength of a generated airflow inside the housing.

In another embodiment of the method according to the invention, the control signals are issued if the pH-value is outside a range between 5.5 to 5.8 and/or if the electrical conductivity is above 2.2 μS/cm and/or if the temperature inside the housing is above 22° C.

In yet another embodiment of the method according to the invention, the computer processor is configured to send a user notification to a user, the user notification being indicative of the liquid level inside the at least one liquid container. Particularly, the computer processor may be configured to send a user notification to a user, once the liquid level inside the at least one liquid container drops below a predetermined amount. As such, the user may be notified if the herbs/and or plants arranged on the trays have absorbed a predetermined amount of liquid comprised by the at least one liquid container, such that the user is guided to refill the liquid container. For example, the notification may be sent once the amount of water in the water container drops below 25% of a volume of the water container that may receive water I and/or once the amount of a nutrient liquid in the nutrient liquid container drops below 25% of a volume of the nutrient liquid container that may receive nutrients. In the same fashion, the notification may be sent once the amount of a pH-minimizer in a pH-minimizer container drops below 25% of a volume of the pH-minimizer container that may receive pH-minimizer.

Particularly, the control unit may be configured to receive data from the camera, wherein the data received from the camera comprise images of the top sides of the trays, particularly of plants and/or herbs arranged on the top sides of the trays. The data from the camera may be evaluated by the computer processor and forwarded to a user, such that a user may monitor the plant growth remotely.

### BRIEF DESCRIPTION OF THE DRAWINGS

Particularly, exemplary embodiments are described below in conjunction with the Figures. The Figures are appended to the claims and are accompanied by text explaining individual features of the shown embodiments and aspects of the present invention. Each individual feature shown in the Figures and/or mentioned in the text of the Figures may be incorporated (also in an isolated fashion) into a claim relating to the vertical farming system and/or the method for monitoring and controlling plant growth according to the present invention.

FIG. 1 shows an example embodiment of a vertical farming system in accordance with the invention in a perspective view;

FIG. 2 shows the example embodiment of FIG. 1 in a first side view;

FIG. 3 shows the example embodiment of FIG. 1 in a second side view;

FIG. 4 shows an exemplary calculation of a tilting moment acting on a vertical farming system according to the invention;

FIG. 5 shows a normalized emission spectrum of a first source of electromagnetic radiation configured to generate electromagnetic radiation and to direct the electromagnetic radiation towards the top sides of the trays, particularly towards plants and/or herbs arranged on the top sides of the trays; and

FIG. 6 shows a normalized emission spectrum of a second source of electromagnetic radiation configured to generate electromagnetic radiation and to direct the electromagnetic radiation into the seedlings drawer, particularly towards seedlings arranged in the seedlings drawer.

### DETAILED DESCRIPTION

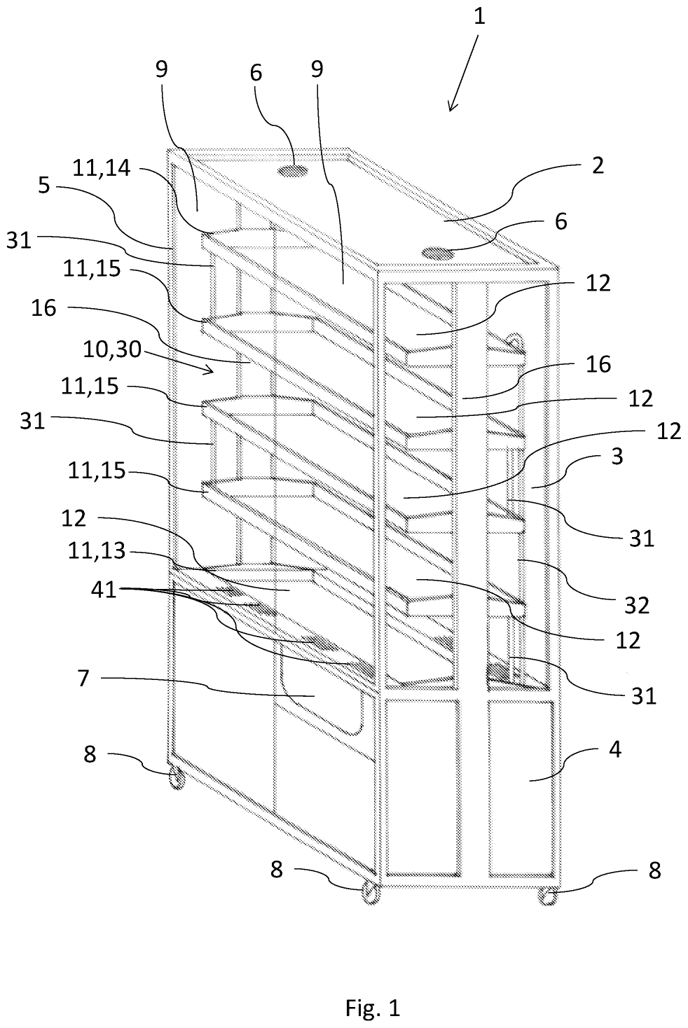

FIG. 1 shows an example embodiment of a vertical farming system 1 in accordance with the invention in a perspective view. The vertical farming system 1 comprises a hydroponic system 10 with a plurality of trays 11 arranged above each other along a first extension direction. To this end, the trays 11 may be interconnected by two opposing connecting members 16 arranged along the first extension direction. In this example embodiment, the hydroponic system 10 comprises five trays 11. The trays 11 each have a top side 12 facing along the first extension direction. The plurality of trays 11 comprises a bottom tray 13 which is the lowest of all trays 11 viewed along the first extension direction. The plurality of trays 11 also comprises a top tray 14 arranged at a top portion of the vertical farming system 1, which is the uppermost of all trays 11 viewed along the first extension direction. Between the bottom tray 13 and the top tray 14, the hydroponic system 10 features one or more intermediate trays 15. The top sides 12 of the bottom tray 13 and the intermediate trays 15 are oriented towards respective adjacent trays 11,14 arranged above the respective tray 13,15.

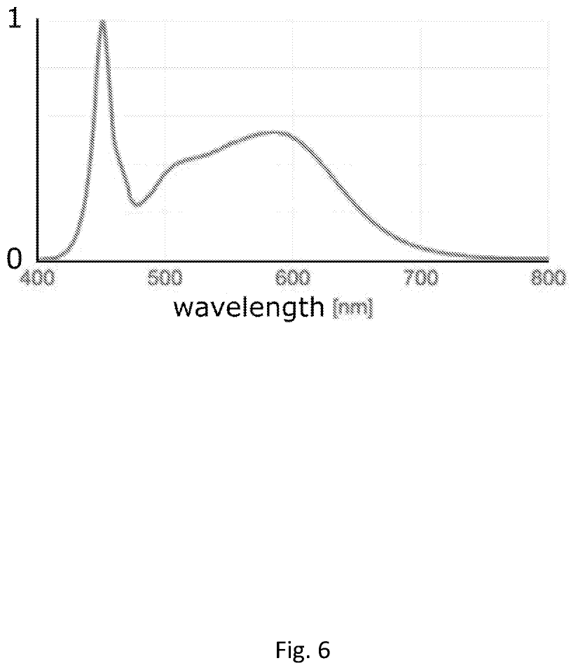

The vertical farming system 1 further comprises a housing 2 with a frame 5. In this example embodiment, the housing 2 features a first and a second portion 3,4, wherein the first portion 3 is arranged above the second portion 4. The trays 11 are arranged in the first portion 3 of the housing 2. For example, the trays 11 and/or the frame may comprise or consist of aluminum, particularly powder-coated aluminum, contributing to an advantageously low weight of the vertical farming system 1. The second portion 4 of the housing 2 comprises a seedlings drawer 7. In FIG. 1, the seedlings drawer 7 is shown in a first position inside the second portion 7 of the housing 2. Preferably, the seedlings drawer 7 is configured and arranged to be moved between the first position and a second position in which the drawer is arranged at least partially outside the housing, such that seedlings may be arranged in and/or harvested from the seedlings drawer 7. For this purpose, the seedlings drawer 7 may be movably connected to the vertical farming system 1, particularly to the housing 2, via rails, sliding guides or the like, such that the seedlings drawer 7 may be moved between said first and second position. Preferably, the seedlings drawer 7 comprises a second source of electromagnetic radiation configured to expose seedlings arranged in the seedlings drawer 7 with electromagnetic radiation, which advantageously contributes to an enhanced growth of the seedlings. An example spectrum that may be used for the second source of electromagnetic radiation is shown found in FIG. 6.

To grow the seedlings in the seedlings drawer 7, a rockwool substrate is preferably soaked in water, put into a plant net and placed in a tub, which is then arranged in the seedlings drawer 7. Then, seeds are arranged on the substrate and the moistened tub is exposed to the electromagnetic radiation of the second source of electromagnetic radiation, contributing to a growth of the seeds into seedlings. Preferably, the seedlings are exposed to electromagnetic radiation up to 22 h to 23 h per day. More preferably and to further enhance the growth of the seeds and/or seedlings, the seeds and/or seedlings should be moistened with water on a daily basis. After about 6 to 10 days of daily manual moistening the seeds in the seedling drawer 7, the seeds have turned into seedlings and may then be manually placed onto trays 11 in the first portion 3 of the housing 2 of the vertical farming system 1, such that the seedlings may grow to plants and/or herbs in the optimized surroundings given in the first portion 3.

As can be further seen in FIG. 1, the hydroponic system 10 further comprises a liquid conduit system 30 with conducts 31. The conducts 31 are arranged along the first extension direction and establish a fluid connection between adjacent trays 11, such that liquid may be conducted between adjacent trays 11, as will be explained below. The liquid circulation system 30 comprises a pump and at least one liquid container configured to receive a liquid, wherein the liquid circulation system 30 is arranged and configured to pump the liquid onto the top side 12 of the top tray 14. The pump may and the at least one liquid container may for example be arranged in the second portion 4 of the housing 2. The liquid conduit system also comprises a pump line 32, such that the liquid may be pumped up the pump line 32, such that the liquid may be delivered onto the top side 12 of the top tray 14.

Once liquid is pumped onto the top surface 12 of the top tray 14, the liquid by gravity distributes over the top surface 12 of the top tray 14 and runs down a conduit 31 to distribute over the top surface 12 of the adjacent intermediate tray 15 below the top tray 14. This process repeats for the intermediate trays 15 until the liquid has distributed over the top surface 12 of the bottom tray 13, whereafter the liquid is conducted to the pump such that it may be repeatedly pumped up the pump line 32 to repeatedly flow along the liquid circuit formed by the liquid circulation system 30. As such, plants and/or herbs arranged on the trays 11 may be provided with an intermittent and/or continuous flow of a liquid, which advantageously enhances their growth.

For example, the liquid circulation system 30 comprises a water container configured to receive water and three nutrient liquid containers configured to receive nutrient liquids. The water container may for example comprise a volume of 1201 and the nutrient liquid containers may be configured to receive a volume of each 2500 ml. Particularly, the control unit may cause the liquid circulation system 30 to add a predetermined amount of water out of the water container into the liquid circuit in predetermined circles. More particularly, the predetermined circles may be adapted to a size and/or a growth stage of the plants, wherein the circles for small plants may be longer for small plants (corresponding to less water consumption) compared to big plans. For example, the control unit may cause the liquid circulation system 30 to add 251 of water every 15 minutes. As such, the vertical farming system 1 may be configured to automatically compensate water absorbed by the plants in order to maintain an optimized plant growth at all times.

The nutrient containers may particularly comprise a pH-minimizer and two fertilizers. For example, the pH-minimizer may comprise 57% water and 43% water soluble phosphorus pentoxide (P2O5). A first fertilizer may comprise the following composition: 3% nitrate nitrogen and 3% micronutrients including calcium, and at least 90% water. The second fertilizer may comprise the following composition: 1% nitrogen, 2% water-soluble phosphate (P2O5), 6% water-soluble potash (K2O), 3% micronutrient such as sulphur (S), 85% water.

As such, the liquid may be a mixture of water and/or a fertilizer and/or a pH-minimizer.

Particularly, the control unit is configured to receive data provided by a sensor arranged and configured to determine the pH-value of the liquid circulating in the liquid conduit system 30, wherein the data are indicative for the pH-value. This may done for example in regular intervals, for example every 10 minutes. The control unit may then, based on the pH-value and particularly if the pH-value exceeds a predetermined value, add a predetermined amount of particularly a pH-minimizer so as to lower the pH-value below the predetermined value. For example, the predetermined amount of pH-minimizer may be 10 ml. Particularly, the pH-value may be increased for example by adding water comprising a pH-value above the pH-value of the liquid circulating in the liquid conduit system 30.

Particularly, the control unit is configured to receive data provided by a sensor arranged and configured to determine the electrical conductivity of the liquid circulating in the liquid conduit system 30, wherein the data is indicative for the electrical conductivity. This may be done in regular intervals, for example every 10 minutes. The control unit may then, based on the electrical conductivity and particularly if the electrical conductivity exceeds a predetermined value, add a predetermined amount of at least one fertilizer so as to lower the electrical conductivity below the predetermined value. For example, the predetermined amount of fertilizer may be 20 ml.

As can further be seen in FIG. 1, the vertical farming system 1 may comprise rollers 8 arranged at a lower terminal section of the vertical farming system 1 or the housing 2. As such, the vertical farming system 1 may be moved by a user over the rollers 8, which advantageously contributes to a simplified positioning and startup of the vertical farming system 1, particularly when used in buildings.

In the example embodiment of FIG. 1, the housing 2 and the frame 5 enclose the hydroponic system 10 in a volume defined by the housing 2 and/or the frame 5. The housing 2 also features openings 6 connecting the volume defined by the housing 2 and/or the frame 5, in other words the inside of the housing 2 and/or the frame 5, with an outside of the housing 2 and/or the frame 5. This particularly allows to at least partially control an air pressure and/or an air flow inside the housing 2 and/or the frame 5, which represent important growth parameters that affect, particularly enhance the growth of plants arranged on the trays 11 inside the housing 2. To this end, the vertical farming system 1 may further comprise a ventilation system. The ventilation system may for example be arranged in the second portion 4 of the housing 2. The ventilation system may comprise a ventilator configured to move air and/or to create an air flow inside the housing 2. To this end, the ventilation system may comprise slits 41 connecting the first and the second portion 3,4 of the housing 2, such that the ventilator may cause an air flow around the trays 11, such that if plants and/or herbs are arranged on the trays 11, the plants and/or herbs may be exposed to the airflow. The ventilation system may also comprise a pump configured to create a pressure difference between a first pressure inside the volume defined by the housing 2 and/or the frame 3 and a second pressure outside the volume. As such, the air inside the housing 2 and/or the frame 5 may be intermittently and/or continuously exchanged by an airflow through the openings 6, while the pump provides fresh air or discharges used air through the slits 41, further contributing to an enhanced growth of plants and/or herbs arranged on the trays 11. Particularly, the control unit may cause the ventilator to adapt the airflow generated by the ventilator based on the temperature inside the housing For example, the control unit may cause the ventilator to generate a maximum airflow, corresponding to a 100% airflow strength, if the temperature is or rises above 28° C., such that the plants are cooled by the airflow. The control unit may cause the ventilator to decrease the airflow strength based on the temperature, for example down to 50% between 22° C. and 27° C. and down to 10% if the temperature is or drops below 22° C. As such, the airflow is adjusted automatically according to the plants and/or herbs needs, which contributes to an enhanced growth and to save energy.

As also shown in FIG. 1, the housing 2 may comprise window door elements 9 and/or window elements. The window door elements 9 are preferably arranged between the frame 5 and may comprise hinges that may for example be arranged on the frame 5, such that the window door elements 9 may be opened and closed. In FIG. 1, the window door elements 9 are shown in a closed configuration, such that the two adjacent window door elements 9 form a closed surface of the housing 2 extending in a plane between the frame. Other planes extending between the frame may be provided with window elements or further window door elements 9. Preferably, and as shown in FIG. 1, the window door elements 9 and the window elements are transparent and comprise glass, particularly laminated security glass, such that plants and/or herbs arranged on the trays 11 may be exposed to natural sunlight, contributing to an enhanced growth, as well as to allow users to visually monitor the growth. By opening the window door elements 9, a user may for example access the trays 11 to arrange and/or harvest plants on and/or from the trays 11.

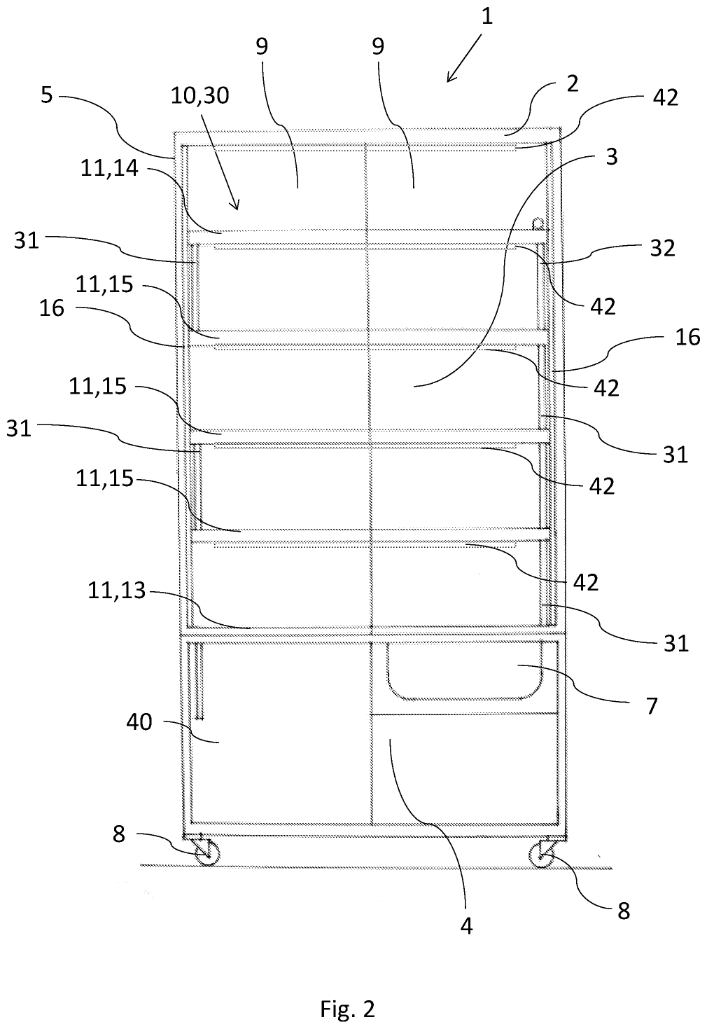

FIG. 2 shows the example embodiment presented in FIG. 1 in a first side view. The explanations concerning the reference signs already listed in FIG. 1 also apply to FIG. 2. In this first side view, the window elements 9 arranged on the first portion 3 of the housing 2 are best seen.

As can further be seen in FIG. 2, the housing 2 may comprise a door element 40. In this example embodiment, the door element 40 is arranged on the second portion 4 of the housing 2. The door element 40 may preferably pivoted around a hinge arranged at the housing 5 between an open position and a closed position, wherein the closed position is depicted in FIG. 2. By opening the door element 40, the inside of the second portion 4 of the housing 2 may be accessed, such that components arranged inside the second portion 4, for example the pump, electrical components, the ventilator, the liquid container or containers, may be accessed by a user, allowing the user to maintain the components and particularly to refill liquids into the liquid containers. Particularly, the second portion 4 may accommodate a central power unit configured to supply the pump, the ventilator, the first and second source of electromagnetic radiation, the sensors and/or the control unit with electricity. The central power unit may be supplied by an external energy source, particularly via a single cable, making the system suitable for use in various buildings by connecting it to the external energy source for example via a socket.

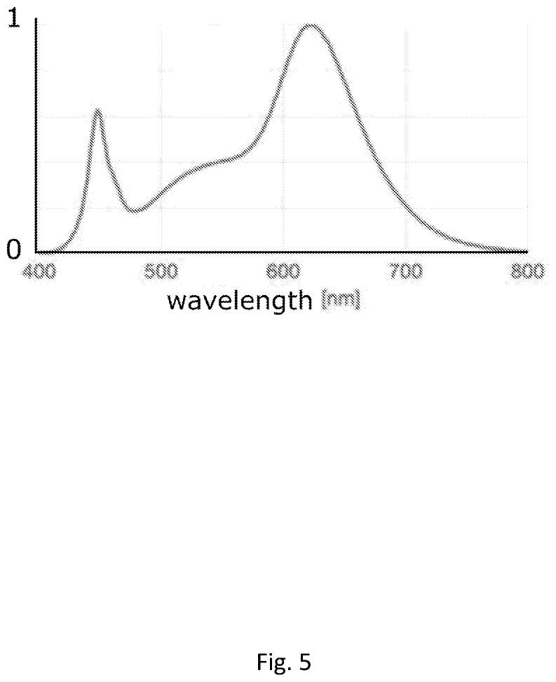

Moreover, FIG. 2 shows multiple first sources 42 of electromagnetic radiation which are arranged on down sides of the intermediate trays 15 and the top tray 14, wherein the down sides are oriented opposite to the top sides 12. A further first source 42 of electromagnetic radiation is arranged above the top tray 14. The first sources 42 of electromagnetic radiation shown here are realized by elongated strips, particularly LED-strips, which contribute to a homogenous distribution of electromagnetic radiation emitted towards the trays 11, particularly towards plants and/or herbs arranged on the trays 11, such that the growth is further enhanced by to the exposure with electromagnetic radiation. An example spectrum that may be used for the first sources 42 of electromagnetic radiation can be found in FIG. 5.

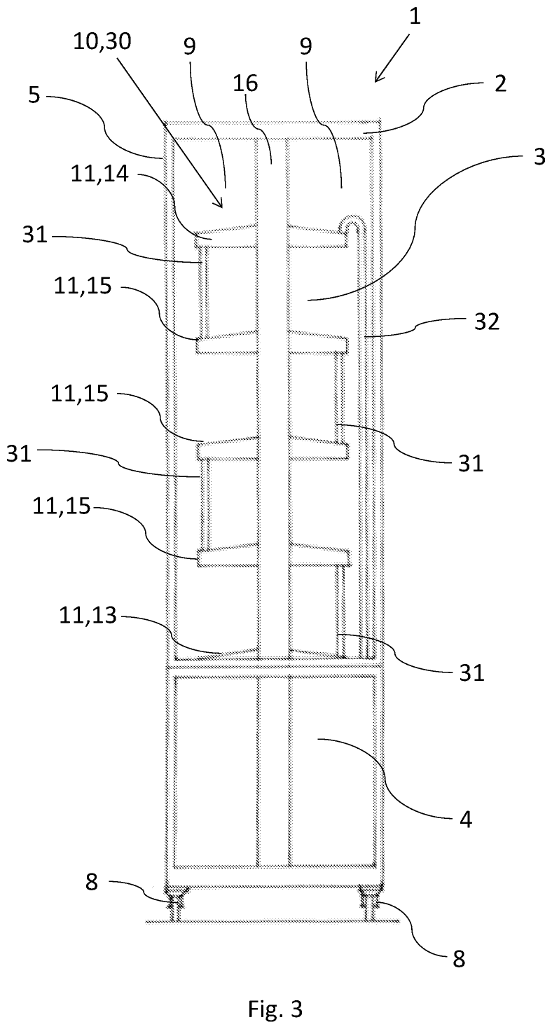

FIG. 3 shows a second side view of the example embodiment presented in FIG. 1. The explanations concerning the reference signs already listed in FIG. 1 also apply to FIG. 2. In FIG. 2, the hydroponic system 10 and the liquid conduit system 30 are best seen. This includes the pump line 32, through which a liquid may be pumped upwards using the pump, such that the liquid may be delivered onto the top side 12 of the top tray 14. As can be further well seen in this second side view, the conducts 31 of the liquid conduit system 30 are arranged on an edge portion of the top side 12 of the trays 11, wherein the conducts 31 of adjacent trays 11 viewed along the first extension direction are arranged on opposite edge portions of the top side 12. As such, when liquid is circulated in the vertical farming system 1, particularly in the liquid conduit system 30, the liquid cascades across the trays 11 and down on alternating edge portions of the trays 11, forming a meandering cascade. While offering an esthetic layout, this particular liquid conduit system 30 at the same time provides that the liquid by gravity runs across the trays 11, such that plants and/or herbs arranged on the trays 11 are advantageously supplied with a particularly continuous liquid flow, which further contributes to an enhanced growth. As can be further understood by comparing FIG. 3 and FIG. 1, the top sides 12 of the trays 11 may comprise a polygonal shape, for example a rectangular shape, wherein the conducts 31 of adjacent trays 11 are arranged on opposite corners of the polygon. This particular layout of the hydroponic system 10 further enhances the growth of plants and/or herbs arranged on the trays 11, as the liquid may run diagonally across the trays.

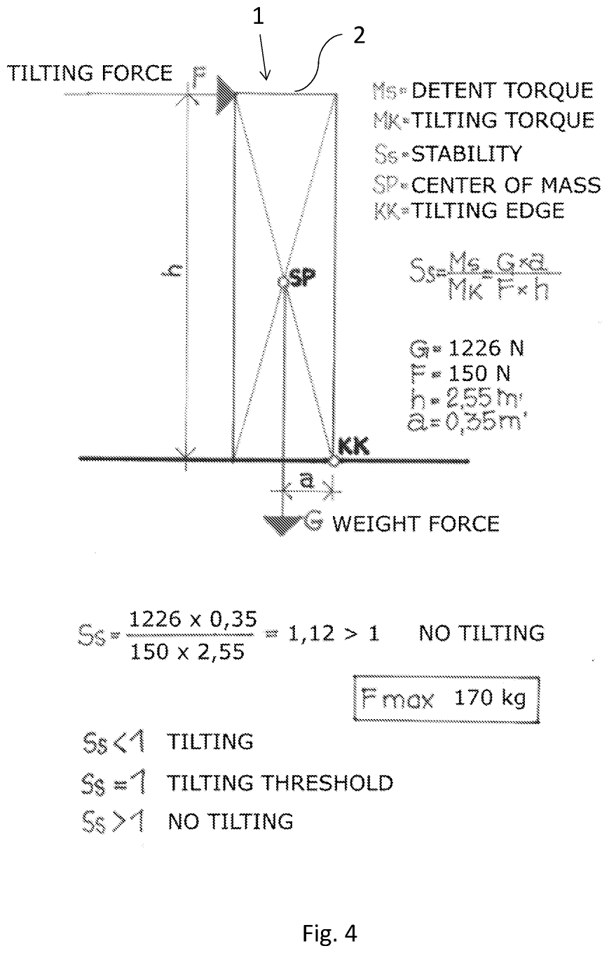

FIG. 4 shows an exemplary calculation of a tilting moment acting on a vertical farming system 1 according to the invention. The vertical farming system 1 is illustrated as a rectangle, wherein the perspective corresponds to the first side view of the exemplary embodiment of FIG. 2. As such, the rectangle sketched here may represent the housing 2 of the vertical farming system 1. The housing 2 may have height h extending along the first extension direction and a width w=2a extending along a second extension direction oriented perpendicular to the first extension direction. In this example, the height h is chosen to be h=2.55 m and the width w is chosen to be w=0.7 m. The total weight of the vertical farming system 1, without plants and/or herbs and/or liquids, is around 125 kg. An example calculation assuming a tilting force of 150 N acting along the second extension direction shows that the resulting tilting torque is smaller than the detent torque, such that the vertical farming system 1 withstands 150 N. Particularly, by the above choice of the height and the width corresponding to an aspect ratio ar=h/w=3.6 and for a weight of 125 kg of the vertical farming system 1, the vertical farming system 1 is configured to withstand tilting forces of up to 170 N acting on the housing 2 along the second extension direction at the highest point of the housing 2 along the first extension direction, as can be understood from the calculation. As such, the vertical farming 1 system is tilt-proof up to 170 N, making it particularly save when used in crowded places like buildings and particular supermarkets. Note that the maximum force increases further once the vertical farming system 1 is loaded with plants and/or herbs and/or liquids, as can also be understood from the calculation.

FIG. 5 shows a normalized emission spectrum of the first source 42 of electromagnetic radiation configured to expose the top sides 12 of the trays 11, particularly plants and/or herbs arranged on the trays 11 with electromagnetic radiation, as depicted in FIG. 2. The spectrum shown in FIG. 5 is a spectrum of an LED light source and based on the natural spectrum of sunlight, such that the vertical farming system 1 may be used to empathize natural growth conditions, such that growth of plants and/or herbs is possible even in places that are not or not sufficiently exposed to natural sunlight. Preferably, the intensity of the electromagnetic radiation emitted by the first source 42 of electromagnetic radiation may be controlled, particularly continuously and steplessly, by the control unit. Particularly, the first source 42 of electromagnetic radiation may be controlled such by the control unit that the first source 42 of electromagnetic radiation exposes the plants and/or herbs arranged on the trays to electromagnetic radiation in predetermined cycles. The predetermined cycles may likewise be based on the activity of the sun, such that the first source 42 of electromagnetic radiation may expose the plants and/or herbs for example in a first period between 12 h and 16 h per day, simulating daylight, followed by a second period between 12 h and 8 h per day in which the first source 42 of electromagnetic radiation is turned off or set to a lower intensity compared to the first period, simulating a night-phase. Optionally, the first and the second period may merge smoothly into one and another in a third and fourth period by dimming the intensity of the electromagnetic radiation up or down, in analogy to a sunrise and a sunset. As such, while offering the user an esthetic dynamic light setting, the plant growth is further enhanced by empathizing natural day/night cycles inside the vertical farming system 1. In an embodiment, a user may set the first and second periods.

FIG. 6 shows a normalized emission spectrum of the second source of electromagnetic radiation configured to expose seedlings arranged in the seedlings drawer 7 with electromagnetic radiation, as explained in FIG. 1. Compared to the spectrum shown in FIG. 5 used to expose the top sides 12 of the trays 11, particularly plants and/or herbs arranged on the trays 11, the spectrum depicted here in FIG. 6 comprises an enhanced intensity of blue wavelengths between 400 nm and 500 nm, which advantageously contributes to an enhanced growth rate of seedlings arranged in the seedlings drawer 7.

We claim:

1. A vertical farming system comprising a hydroponic system, the hydroponic system comprising:
a plurality of trays arranged above each other along a first extension direction, the trays each having a top side facing along the first extension direction, wherein the plurality of trays comprises a bottom tray, one or more intermediate trays and a top tray, the bottom tray being arranged at a bottom portion of the farming system, wherein the bottom tray faces with its top side toward the one or more intermediate trays and toward the top tray, wherein the top tray is arranged at a top portion of the farming system such that the one or more intermediate trays are between the top tray and the bottom tray,
a liquid circulation system comprising a liquid pump, the circulation system being arranged and configured to pump a liquid onto the top side of the top tray and
a liquid conduit system fluidically connecting adjacent trays of the plurality of trays,
wherein the farming system is configured such that when the liquid circulation system pumps the liquid onto the top side of the top tray, the liquid is conducted downwards via the top side of each tray by the liquid conduit system and wherein the liquid circulation system is adapted and configured to intermittently and/or continuously pump the liquid back onto the top side of the top tray so as to form a liquid circuit.

2. The vertical farming system according to claim 1, wherein each tray comprises a holding member adapted and configured to hold plants on the trays, such that if the liquid is delivered by the liquid circulation system and if the plants are held on the tray, the plants are at least partially immersed in the liquid conducted via the top sides of the trays, such that a plant growth is enhanced by the liquid.

3. The vertical farming system according to claim 1, wherein the liquid conduit system comprises conducts arranged on or through an edge portion of the top side of the trays, wherein the conducts of adjacent trays are arranged on opposite edge portions of the top side, particularly such that when liquid is circulated in the vertical farming system, the liquid cascades across the trays and down on alternating edge portions of the trays, forming a meandering cascade.

4. The vertical farming system according to claim 3, wherein the top sides of the trays comprise a polygonal shape along a second extension direction oriented perpendicularly to the first extension direction and wherein the conducts of adjacent trays are arranged on opposite corners of the polygons, particularly such that when liquid is circulated in the vertical farming system, the liquid runs diagonally across the trays.

5. The vertical farming system according to claim 1, further comprising a housing, wherein the trays are arranged within the housing.

6. The vertical farming system according to claim 5, further comprising a ventilation system comprising a ventilator arranged and configured to cause an airflow inside the housing.

7. The vertical farming system according to claim 5, wherein the housing comprises at least one opening, such that air may be conducted from an inside to an outside of the housing and/or vice versa.

8. The vertical farming system according to claim 5, characterized in that the housing comprises a first and a second portion, wherein the first portion accommodates the plurality of trays and wherein the second portion comprises a seedlings drawer configured and arranged to be moved between a first position inside the second portion of the housing and a second position in which the drawer is arranged at least partially outside the housing, particularly such that seedlings may be arranged in and/or harvested from the seedlings drawer.

9. The vertical farming system according to claim 8, further comprising at least a second source of electromagnetic radiation configured to generate and emit a second electromagnetic radiation into the seedlings drawer.

10. The vertical farming system according to claim 1, further comprising at least a first source of electromagnetic radiation configured to generate and direct a first electromagnetic radiation toward the top sides of the trays.

11. The vertical farming system according to claim 1, wherein the liquid circulation system further comprises at least one liquid container configured to receive a liquid, wherein the at least one liquid container is or is configured to be fluidically connected with the liquid circulation system such that the liquid of the at least one liquid container or a plurality of liquids from a plurality of liquid containers may be pumped onto the top side of the top tray via the liquid circuit.

12. The vertical farming system according claim 1, further comprising a lower terminal section comprising rollers, such that the vertical farming system may be moved by rolling the vertical farming system with the rollers.

13. The vertical farming system according to claim 1, wherein the vertical farming system comprises:
a maximum vertical extent h extending along the first extension direction and a minimum lateral extent w perpendicular to said vertical extent, wherein an aspect ratio ar=h/w is between 3 and 4, and
a total weight between 100 kg and 150 kg without herbs and/or plants and liquid,
such that the vertical farming system is configured to withstand maximum lateral forces between 125 N and 250 N without tilting.

14. The vertical farming system according claim 1, further comprising sensors configured to determine a characteristic value selected from a group consisting of: a pH-value of the liquid, an electrical conductivity of the liquid, a liquid level in at least one liquid container, a temperature inside the housing.

15. The vertical farming system according to claim 1, further comprising a control unit, wherein the control unit is configured to receive data from and/or to send control signals to components of the vertical farming system, wherein the components are comprised by a group consisting of: the sensors, the first source of electromagnetic radiation, the second source of electromagnetic radiation, and/or the liquid circulation system.

16. A method for monitoring and controlling plant growth based on data received and/or control signals sent by the control unit of the vertical farming system of claim 15, wherein the received data are evaluated by a computer processor and wherein by sending control signals to the components, the components of the vertical farming system are caused to perform an action based on the received control signals.

17. The method according to claim 16, wherein the data received by the computer processor comprise information indicative of a pH-value of the liquid and/or an electrical conductivity of the liquid and/or a temperature inside the housing and/or a liquid level inside the at least one liquid container and wherein depending on the received data the computer processor issues a control signal via the control unit to at least one of the following components:
the first source of electromagnetic radiation, causing said first source to change an intensity of the first electromagnetic radiation directed toward the top sides of the trays,
the liquid circulation system, causing the liquid circulation system to adjust a liquid pumping rate, to start pumping or to stop pumping at least one liquid comprised by the at least one liquid container into the liquid circuit,
the ventilation system, causing the ventilation system to change a strength of a generated airflow inside the housing.

18. The method according to claim 17, wherein the control signals are issued if the pH-value is outside a range between 5.5 to 5.8 and/or if the electrical conductivity is above 2.2 pS/cm and/or if the temperature inside the housing is above 22° C.

19. The method according to claim 17, wherein the computer processor is configured to send a user notification to a user, the user notification being indicative of the liquid level inside the at least one liquid container.
